(19) United States
(12) Patent Application Publication
(10) Pub. No.: US 2010/0321231 A1
(43) Pub. Date: Dec. 23, 2010

(54) RADAR DEVICE

(76) Inventor: Masahiro NAKAHAMA, Nishinomiya-City (JP)

Correspondence Address: BIRCH STEWART KOLASCH & BIRCH, PO BOX 747, FALLS CHURCH, VA, 22040-0747, US

(21) Appl. No.: 12/819,963

(22) Filed: Jun. 21, 2010

(30) Foreign Application Priority Data
Jun. 22, 2009 (JP) 2009-147745

(51) Int. Cl. G01S 13/08; G01S 13/00

(52) U.S. Cl. 342/118; 342/159

(57) ABSTRACT

The disclosure provides a radar device, which includes a determination module for extracting received data within a predetermined distance range out of a series of received data for which received signals are sampled, and determining whether the distance range is a distance range where rain-and-snow clutters or white noises are dominant, using the extracted received data.

### CROSS-REFERENCE TO RELATED APPLICATION(S)

This application claims priority under 35 U.S.C. §119 to Japanese Patent Application No. 2009-147745, which was filed on Jun. 22, 2009, the entire disclosure of which is hereby incorporated by reference.

### TECHNICAL FIELD

The present invention relates to a radar device for suppressing rain clutters and/or snow clutters.

### BACKGROUND

Typically, radar devices receive by an antenna, echoes (reflection waves) from target objects or lands, as well as echoes from water waves (water surface reflections such as sea surface reflections) and echoes from rain and/or snow (rain-and-snow clutters). Therefore, various proposals of techniques for removing such unused reflection waves (clutters) have been made. Among these techniques, a number of techniques for suppressing the rain-and-snow clutters are made because the rain-and-snow clutters are difficult to be suppressed due to a signal level of the received data thereof typically varying greatly depending on weather conditions in addition to a distance of the rain and/or snow from a ship position. For example, in ship radar, differentiation processing in a range direction (FTC: Fast Time Constant), LOG/CFAR (Constant False Alarm Rate) and the like are known as the techniques for suppressing the rain-and-snow clutters.

Meanwhile, JP2002-243842(A) discloses a configuration in which input signals are clamped by a predetermined threshold (clamp level), and highly random signals (rain-and-snow clutters, etc.) are removed by correlation processing being applied to extract only reflection signals from target objects.

However, in the FTC processing, it is difficult to remove the rain-and-snow clutters where a rainfall amount is comparatively little with a frequency component being high. On the contrary, in the LOG/CFAR processing, there is a problem in which land echoes are also erased together with the rain-and-snow clutters when there is a large amount of rainfall with the rain-and-snow clutters being strong. Further, with the configuration of JP2002-243842(A), when the threshold for clamping the input signals is not appropriately set, the rain-and-snow clutters may not be properly removed.

As described above, in the conventional radar devices, there may be a case where the rain-and-snow clutter suppression is not enough, and a case where the echoes other than the rain-and-snow clutters may be erased.

### SUMMARY

The present invention is made in view of the above situations, and provides a radar device that can properly suppress only a rain-and-snow clutter, leaving an echo from a land or a target object.

According to an aspect of the invention, a radar device includes a determination module for extracting received data within a predetermined distance range out of a series of received data for which received signals are sampled, and determining whether the distance range is a distance range where rain-and-snow clutters or white noises are dominant, using the extracted received data.

The determination module may calculate a cumulative frequency with a signal level being a class value, for the extracted received data within the predetermined distance range, and determine whether the distance range is a distance range where the rain-and-snow clutters or the white noises are dominant based on whether a width of the class value corresponding to the predetermined range of the cumulative frequency is above a predetermined value.

The determination module may calculate a maximum value and a minimum value of the signal level for the extracted received data within the predetermined distance range, and determine whether the distance range is a distance range where the rain-and-snow clutters or the white noises are dominant based on whether a difference of the maximum value and the minimum value is above a predetermined value.

The determination module may calculate a rainfall amount level corresponding to a predetermined rainfall based on a radar equation, obtain the number of the received data having a signal level exceeding the rainfall amount level for the extracted received data within the predetermined distance range, and determine whether the distance range is a distance range where the rain-and-snow clutters or the white noises are dominant based on whether the number of the received data exceeding the rainfall amount level is above a predetermined value.

The radar device may suppress the rain-and-snow clutters contained in the received data based on a threshold, and may further include a threshold output module for determining the threshold for each predetermined distance range. The threshold output module may include an internal data basis threshold calculation module for calculating an internal data basis threshold as the threshold for the distance range based on the received data within the distance range determined to be the distance range where the rain-and-snow clutters or the white noises are dominant.

The threshold output module may include a threshold interpolation module for calculating the threshold for the distance range determined to be the distance range where the rain-and-snow clutters or the white noises are not dominant. The threshold interpolation module may determine the threshold based on the internal data basis threshold for the distance range determined to be the distance range where the rain-and-snow clutters or the white noises are dominant. The distance range may be other distance ranges adjacent to the distance range concerned for which the threshold is to be calculated.

The threshold output module may include a threshold determination module for adopting as the threshold a value obtained by subtracting a predetermined offset from the rainfall amount level calculated based on the radar equation for the distance range determined to be the distance range where the rain-and-snow clutters or the white noises are not dominant.

### BRIEF DESCRIPTION OF THE DRAWINGS

The present disclosure is illustrated by way of example and not by way of limitation in the figures of the accompanying drawings, in which the like reference numerals indicate like elements and in which:

FIG. 1 is a block diagram showing a substantial configuration of a radar device according to an embodiment of the present invention;

FIG. 2 is a data flow diagram in a rain-and-snow clutter suppression module;

FIG. 3 is a graph showing a curve of histogram integrated values;

FIG. 4 is a view illustrating a difference of a maximum value and a minimum value within a distance range;

FIG. 5 is a graph showing an example of a predetermined rainfall amount level curve; and

FIG. 6 is a schematic diagram illustrating distance ranges adjacent to a ship concerned in a distance direction and an azimuth direction.

### DETAILED DESCRIPTION

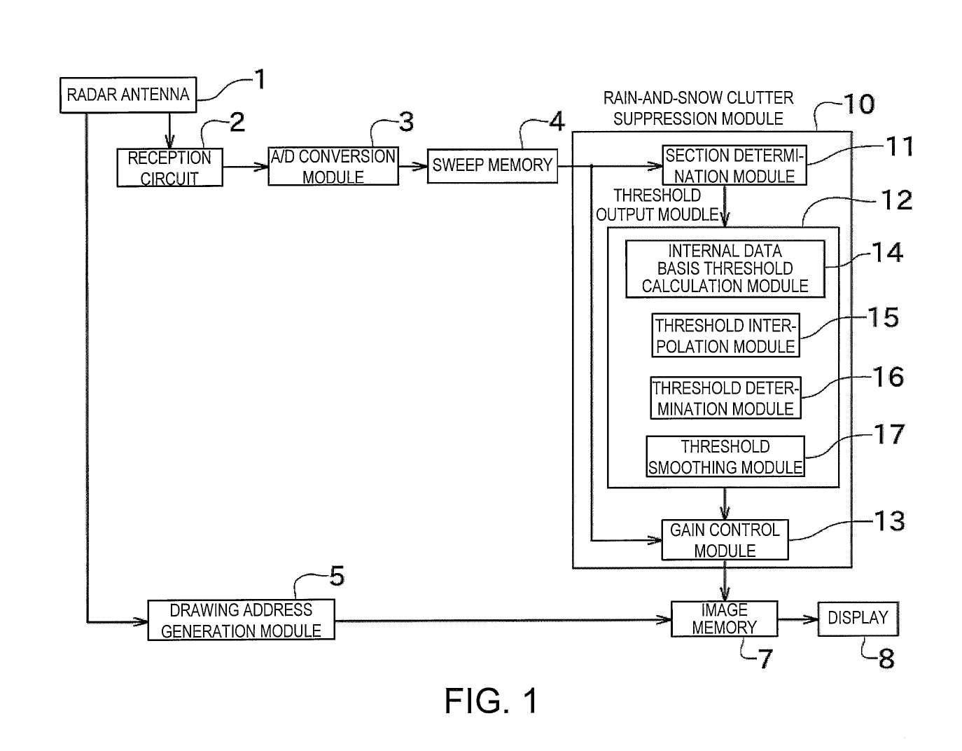

Hereinafter, an embodiment of the present invention is described with reference to the accompanying drawings. FIG. 1 is a block diagram showing a substantial configuration of a radar device for ships according to this embodiment. Although this embodiment describes the radar device for ships as an example, applications of the radar device of the present invention is not limited to a ship, and may be any other movable body, such as a boat, vessel, vehicle, airplane or the like.

As shown in FIG. 1, the radar device of this embodiment is provided with a radar antenna 1, which emits a radiation signal with a sharp directivity (pulse-shaped electric wave), and receives an echo from a land or a target object around the radar device (reflection signal). The radar antenna 1 repeats the transmission and reception of the signal while rotating in a horizontal plane at a predetermined rotation cycle.

A display 8 may typically be a CRT, a LCD or the like, and may be a raster scan-type display in which a graphical indication is possible.

Typically, a period of time from the radar antenna 1 emitting the radiation signal until the antenna receiving the returned echo is proportional to a distance from the radar antenna 1 to the land or target object. Therefore, assuming that the period of time from emission of the radiation signal to reception of the echo signal (received signal) is a moving radius R and an antenna angle when performing the transmission and reception of the signals is a deflection angle θ, a position of the land or target object can be acquired in a polar coordinate system centering on the radar antenna 1. Then, a radar image can be obtained by plotting the position of the land or target object acquired in the polar coordinate system on a plane. The radar device of this embodiment displays the radar image on the display 8 to allow an operator to check the situation of the land or target object around the radar device.

The radar antenna 1 also receives an echo from rain and/or snow (hereinafter, referred to as “a rain-and-snow clutter”) other than the echo from the land or target object. In addition, the signal received by the radar antenna 1 may contain a white noise. Therefore, if the signal received by the radar antenna 1 is displayed as it is on the display 8, a radar image where the rain-and-snow clutters and the like are plotted together with the land and target object will be displayed. The term used herein, “rain-and-snow clutter” and “white noise” may be collectively referred to as “highly random clutter.”

The radar device of this embodiment is also provided with a rain-and-snow clutter suppression module 10 for suppressing such a highly random clutter to display only the positions of the land and target object on the display 8. Thereby, the operator of the radar device can visually recognize the land and target object easily even at the time of rainy weather or the like. The configuration for suppressing the highly random clutter will be described in detail later.

Next, a configuration of each component of the radar device is described in detail below.

A reception circuit 2 detects and amplifies the signal which the radar antenna 1 received, and outputs it to an A/D conversion module 3. The A/D conversion module 3 samples the analog received signal, and converts it into digital data containing two or more bits (received data). Here, a value indicative of the received data corresponds to an intensity of the signal which the radar antenna 1 received (signal level). The A/D conversion module 3 outputs the received data to a sweep memory 4.

The sweep memory 4 is a buffer that can store the received data in real time for one sweep. The term used herein, “sweep” means a series of operations from emission of a radiation signal to emission of a subsequent radiation signal, and “received data for one sweep” means a series of data sampled in a period of time from the emission of the radiation signal to the emission of the subsequent radiation signal. When new received data is written in from the A/D conversion module, the sweep memory 4, which is the buffer, sequentially outputs the received data to the rain-and-snow clutter suppression module 10 before the received data is overwritten by the next sweep.

The rain-and-snow clutter suppression module 10 includes hardware, such as a CPU, a RAM, and a ROM, and software, such as a program or programs stored in the ROM. By the hardware and software cooperate with each other, the rain-and-snow clutter suppression module 10 functions as a section determination module (determination module) 11, a threshold output module 12 and the like, described below The rain-and-snow clutter suppression module 10 performs predetermined statistical processing to a group of the received data which is constituted by the received data inputted sequentially from the sweep memory 4 to determine a rain-and-snow clutter removing threshold which is a threshold for removing the rain-and-snow clutters and the white noises (described later in detail).

The rain-and-snow clutter suppression module 10 functions also as a gain control module 13. The gain control module 13 is inputted with the rain-and-snow clutter removing threshold, as well as the received data from the sweep memory 4. The gain control module 13 outputs the received data to an image memory 7 as it is, if the signal level of the inputted received data is above the rain-and-snow clutter removing threshold. On the other hand, if the signal level of the received data is below the rain-and-snow clutter removing threshold, the gain control module 13 outputs, for example, zero as a value of the signal level to the image memory 7. Thereby, the received data from which the highly random clutter is removed is outputted to the image memory 7. Note that the received data from which the highly random clutter is removed may be particularly referred to as “highly random clutter removed data.”

The image data of the radar image to be displayed on the display 8 is stored in the image memory 7. Typically, the image data is raster data containing two or more pixels, and is read at a high speed synchronizing with the raster scanning of the display 8.

In the image data, each pixel is stored so as to be arranged in an XY orthogonal coordinate system where the Y-axis is set to a bow direction and the X-axis is set to a beam direction of the ship, for example. The data indicative of the signal level at a position of each pixel (highly random clutter removed data, described above) is stored in the pixel concerned. When reading out the image data synchronizing with the raster scanning of the display 8, a pixel with a stronger signal level is displayed in a darker color and a pixel with a weaker signal level is displayed in a lighter color, for example; thereby the situation of the land or target object around the radar device can be displayed in a horizontal plane (radar image) on the display 8.

A drawing address generation module 5 is inputted with the sweep angle data with respect to a predetermined direction, for example, a bow direction (data indicative of the angle θ of the radar antenna 1) from the radar antenna 1. The drawing address generation module 5 generates an address for specifying a corresponding pixel based on the angle θ of the radar antenna 1 and the distance data R corresponding to the period of time from emission of the radiation signal to reception of the echo. That is, the drawing address generation module 5 converts the position of the land or target object acquired in the polar coordinate system (R, θ) into data of the XY orthogonal coordinate system, and generates an address (X, Y) of the pixel corresponding to the position of the land or target object concerned.

When the highly random clutter removed data is outputted to the image memory 7 from the gain control module 13, the address (X, Y) calculated by the drawing address generation module 5 is inputted into the specified address portion of the image memory 7. Thereby, the highly random clutter removed data can be stored at the corresponding pixel. As a result, the image data where the signal level is plotted on the plane corresponding to the position of the land or target object is generated, and based on this, the radar image can be displayed on the display 8.

Next, the rain-and-snow clutter suppression module 10 is described in detail. As described above, the rain-and-snow clutter suppression module 10 includes the section determination module 11 and the threshold output module 12.

The threshold output module 12 obtains the rain-and-snow clutter removing threshold based on the received data from the sweep memory 4, and outputs it to the gain control module 13. The rain-and-snow clutter removing threshold may be, for example, a fixed value; however, in this case, it cannot properly support a change of the rainfall amount or the like. Therefore, in this embodiment, as described above, the threshold output module 12 obtains the rain-and-snow clutter removing threshold based on actual received data to automatically determine the threshold that can properly suppress the highly random clutter which is being generated at that time point.

Here, if the rain-and-snow clutter removing threshold is too small comparing with the signal level of the highly random clutter, a suppression effect of the highly random clutter cannot fully be demonstrated. On the other hand, when the rain-and-snow clutter removing threshold is too large comparing with the signal level of the highly random clutter, there is a possibility of erasing the necessary echo from the land or target object. For this reason, as for the rain-and-snow clutter removing threshold, it is preferred to determine a value that can appropriately remove the highly random clutter based on the signal level of the highly random clutter

However, in the received data inputted from the sweep memory 4, the highly random clutter and the echo from the land or target object are mixed. Typically, the signal level of the echo from the land or target object is stronger compared with the signal level of the highly random clutter. Therefore, if the rain-and-snow clutter removing threshold is obtained based on the received data containing the echo from the land or target object, the rain-and-snow clutter removing threshold tends to become greater. Thus, there is a problem in which the echo from the land or target object may also be disappeared by using the rain-and-snow clutter removing threshold obtained based on the received data containing the echo from the land or target object.

For this reason, the radar device of this embodiment includes the section determination module 11 to determine whether each of the predetermined distance ranges is suitable for calculating the rain-and-snow clutter removing threshold.

As described above, the received data is sequentially inputted into the section determination module 11 from the sweep memory 4. The section determination module 11 extracts received data within each predetermined distance range from the series of received data containing the received data inputted from the sweep memory 4.

Next, the section determination module 11 calculates parameters by performing statistical processing of the received data falling within the distance range concerned. Then, using the parameters, each distance range is determined whether it is a distance range where the rain-and-snow clutters or the white noises are dominant.

Herein, the distance range where the rain-and-snow clutters or the white noises are dominant is referred to as a “rain-snow/noise section.” On the other hand, a distance range where the rain-and-snow clutters or the white noises are not dominant may be considered that it contains many received data indicative of the echoes from the land(s) or target object(s), and therefore, it is referred to as a “land/target-object section.”

That is, the distance range determined to be the “rain-snow/noise section” is a distance range where the echoes from the land(s) or target object(s) are not dominant, but the rain-and-snow clutters or the white noises are dominant. Therefore, the rain-and-snow clutter removing threshold for the distance range can be appropriately calculated based on the received data within the distance range concerned.

Therefore, in the distance range determined to be the “rain-snow/noise section,” the calculation of the rain-and-snow clutter removing threshold based on the data within the distance range is considered to be suitable because the highly random clutter can properly be removed. Note that, for the distance range which is the rain-snow/noise section, the rain-and-snow clutter removing threshold obtained based on the received data within the distance range may be referred to as an “internal data basis threshold” in this embodiment.

On the other hand, because the echo from the land or target object is intermingled therewith in the received data within the distance range determined to be the “land/target-object section,” it is difficult to appropriately obtain the rain-and-snow clutter removing threshold based on the received data within the distance range concerned.

As described above, in the distance range of the “land/target-object section,” calculating the rain-and-snow clutter removing threshold based on the data within the distance range has a possibility of resulting in erasing the echo of the land or target object and, thus, it may not be suitable. Therefore, for the distance range determined to be the land/target-object section, it is preferred to calculate the rain-and-snow clutter removing threshold without being based on the received data within the distance range.

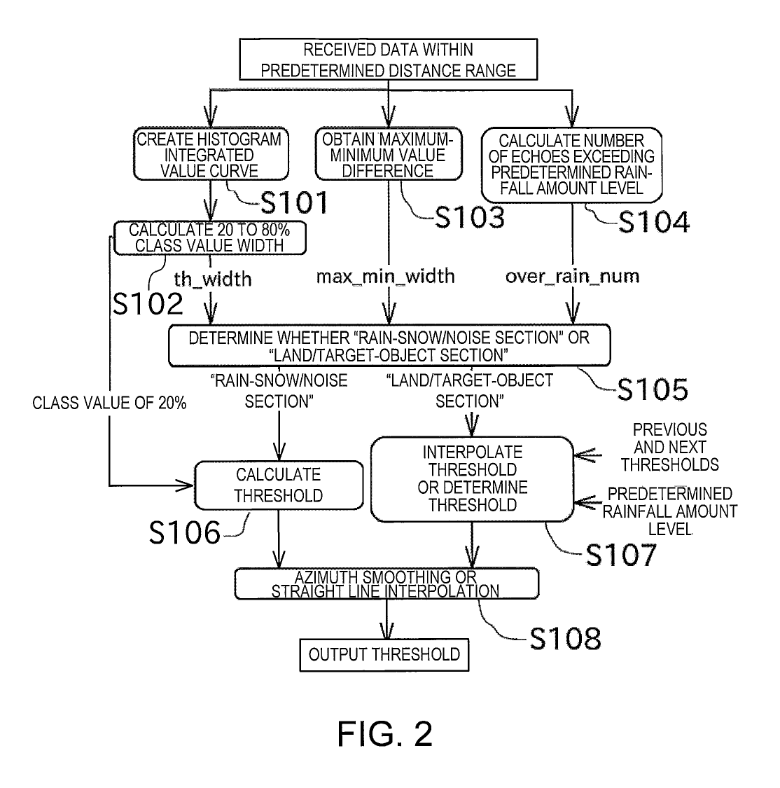

Hereinafter, referring to FIG. 2, a configuration for determining whether each distance range is either the “rain-snow/noise section” or the “land/target-object section” is described. FIG. 2 is a data flow diagram in the rain-and-snow clutter suppression module 10 of this embodiment.

The section determination module 11 calculates, each time a group of the received data over a predetermined distance range (for example, received data of N points) is inputted from the sweep memory 4, three parameters “th_width,” “max_min_width,” and “over_rain_num” based on the received data of N points. That is, the section determination module 11 calculates the three parameters for every distance range. Hereinafter, each parameter is described.

The “th_width” is a parameter indicative of a class value width corresponding to a histogram integrated value over a predetermined range. When calculating the th_width value, the section determination module 11 first obtains a histogram integrated value curve which can be obtained by plotting the number of the received data having a signal level more than a class value, for the received data of N points within the distance range currently processed (S101).

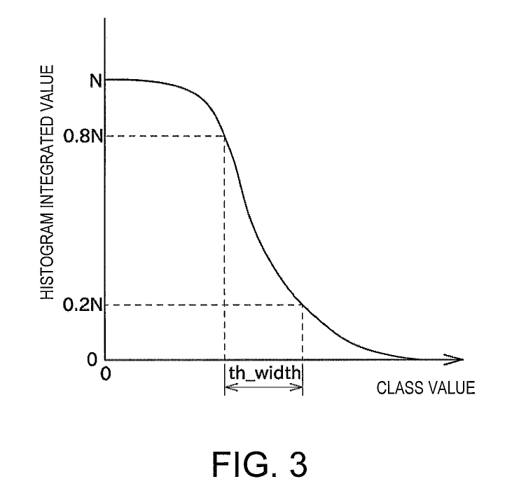

FIG. 3 conceptually shows the histogram integrated value curve. In FIG. 3, the horizontal axis represents the class value (signal level), and the vertical axis represents the number of the received data having signal levels more than the class value (histogram integrated value). Note that it can be said that FIG. 3 is equivalent to a common cumulative-frequency-distribution graph which is inverted (that is, when the class value of the horizontal axis represents 0, the value of the vertical axis is always at N), and the section determination module 11 obtains a cumulative frequency of the received data of N points within each distance range, where the signal level is set to the class value.

Next, the section determination module 11 obtains a width of the class value corresponding to a predetermined width of the histogram integrated value (S102). In this embodiment, a width of the class value (20 to 80% class value width) corresponding to a range where the histogram integrated value becomes from 20% to 80% of the whole (N points) is obtained. That is, in the histogram integrated value curve of FIG. 3, a difference between the class value when the histogram integrated value of the vertical axis becomes 20% and the class value when the value becomes 80% is set to the th_width value for the distance range currently processed. Note that, at this time, the class value when the histogram integrated value obtained by the section determination module 11 becomes 20% is outputted to the threshold output module 12.

The “max_min_width” value is a difference between a maximum value and a minimum value of the received data of N points within the distance range concerned. The section determination module 11 obtains the maximum value and the minimum value out of the received data of N points within the distance range currently processed, and sets the difference as the max_min_width value for the distance range concerned (S103).

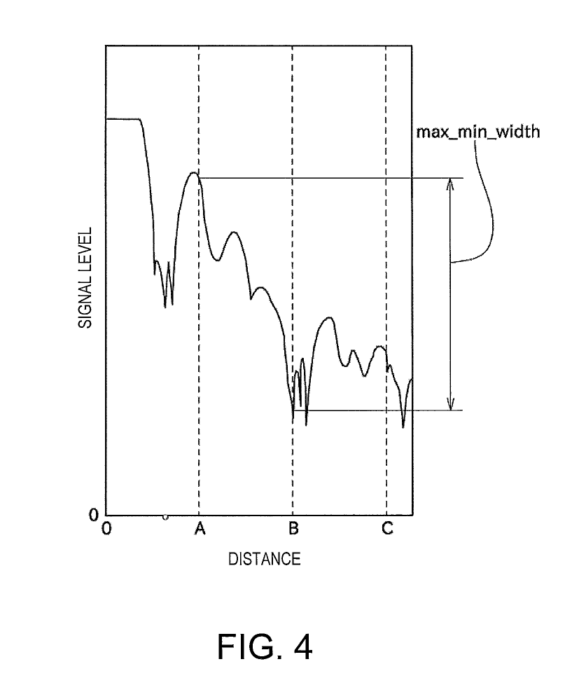

FIG. 4 shows a part of the series of received data in a certain sweep as an example. In FIG. 4, the horizontal axis represents a distance from the radar antenna, and the vertical axis represents a signal level. In addition, the entire distance range divided by dotted lines corresponding to each N points of the received data is shown in FIG. 4. That is, the received data of N points are contained in one of the distance ranges from the position of the antenna (origin O) to a distance A, another distance range from the distance A to a distance B, and another distance range from the distance B to a distance C, respectively. In FIG. 4, the max_min_width value is calculated for the distance range from the distance A to the distance B.

The “over_rain_num” value is a total number of the received data exceeding a predetermined rainfall amount level calculated based on the radar equation, among the received data of N points within the distance range concerned. When calculating the over_rain_num value, the section determination module 11 first calculates a signal level of the rain-and-snow clutter at the time of a predetermined rainfall amount (predetermined rainfall amount level) based on the radar equation.

Hereinafter, a method of deriving an equation for calculating the predetermined rainfall amount level from the radar equation is described briefly. A received power Pr can be expressed by the following Equation (1) from the radar equation. Here, Pt (unit: W) is a radar transmitting power (peak transmitting power), G (unit: dB) is an antenna gain, λ (unit: m) is a wavelength, and σ_{c} (unit: m²) is a target effective reflection cross-sectional area, and R (unit: m) is a distance to a detection target.

$$\overline{Pr} = \frac{{P}_{t} {G}^{2} {λ}^{2} {σ}_{c}}{{( 4 π )}^{3} {R}^{4}} \qquad ( 1 )$$

The target effective reflection cross-sectional area σ_{c} of rain can be expressed by the following Equation (2). Here, Vc (unit: m³) is a target volume (volume of the rain contained in a beam width), η (unit: m²/m³) is a reflectance of the rain-and-snow clutters per unit area, and σᵢ (unit: m²/m³) is a reflectance of a single raindrop.

$${σ}_{c} = {V}_{c} η = {V}_{c} {\sum }_{i} {σ}_{i} \qquad ( 2 )$$

The volume Vc of the rain contained in the beam width can be expressed by the following Equation (3). Here, θ_{B} (unit: rad) is an antenna horizontal beam width, φ_{B} (unit: rad) is an antenna vertical beam width, c (unit: m/s) is a speed of light, and τ (unit: m) is a pulse width. Note that, in Equation (3), π/4 is an ellipse correction parameter value of an antenna beam irradiation range, and 1/(2 ln 2) is a correction amount of an effective volume of the rain by the transceiving antenna where a beam pattern follows the Gaussian distribution.

$${V}_{c} = \frac{π}{4} ( R {θ}_{B} ) ( R {φ}_{B} ) ( \frac{C τ}{2} ) \frac{1}{2 ln 2} \qquad ( 3 )$$

The received power Pr can be expressed by the following Equation (4) using Equations (1) to (3).

$$\overline{Pr} = \frac{{P}_{t} {G}^{2} {λ}^{2} {θ}_{B} {φ}_{B} c τ}{1024 ( ln 2 ) {π}^{2} {R}^{2}} {\sum }_{i} {σ}_{i} \qquad ( 4 )$$

Further, because the antenna gain can be approximated by G=π²/θ_{B}φ_{B}, the following Equation (5) can be obtained using Equation (4).

$$\overline{Pr} = \frac{{P}_{t} G {λ}^{2} c τ}{1024 ( ln 2 ) {R}^{2}} {\sum }_{i} {σ}_{i} \qquad ( 5 )$$

Here, assuming that the raindrop has a spherical shape of a diameter Dᵢ and its circumference is sufficiently short compared with a wavelength of the radar, the reflectance σᵢ of the single raindrop can be expressed by the following Equation (6). Here, Dᵢ (unit: mm) is the diameter of the single raindrop, and c is a dielectric constant of water (80.4 at 20° C.).

$${σ}_{i} = \frac{{π}^{5} {D}_{i}^{6}}{{λ}^{4}} ( ε - 1 ) / ( ε + 2 ) \qquad ( 6 )$$

Substituting Equation (6) into Equation (5), the following Equation (7) can be obtained.

$$\overline{Pr} = \frac{{π}^{5} {P}_{t} Gc τ}{1024 ( ln 2 ) {R}^{2} {λ}^{2}} ( ε - 1 ) / ( ε + 2 ) {\sum }_{i} {D}_{i}^{6} \qquad ( 7 )$$

ΣDᵢ⁶ is called “radar reflectivity factor Z” and is a parameter dependent on a rainfall amount “r.” That is, Equation (7) can be expressed by the following Equation (8) using the radar reflectivity factor Z.

$$\overline{Pr} = \frac{{π}^{5} {P}_{t} Gc τ}{1024 ( ln 2 ) {R}^{2} {λ}^{2}} ( ε - 1 ) / ( ε + 2 ) \cdot Z \qquad ( 8 )$$

The radar reflectivity factor Z can be expressed by approximate equations obtained by experiments as follows.

$$\overline{Pr} = \frac{200 {π}^{5} {P}_{t} Gc τ {r}^{1.6}}{1024 ( ln 2 ) {R}^{2} {λ}^{2}} ( ε - 1 ) / ( ε + 2 ) \cdot {10}^{- 18} \qquad ( 10 )$$

Substituting the general expression best used among Equation (9) into Equation (8), the following Equation (10) can be obtained. Here, “r” (unit: mm/h) is a rainfall amount.

$$Z = 200 {r}^{1.6} \times {10}^{- 18} ( General Expression ) \\ Z = 31 {r}^{1.71} \times {10}^{- 18} ( Orographic Rainfall ) \\ Z = 48 {r}^{1.37} \times {10}^{- 18} ( Thunder Showers ) \qquad ( 9 )$$

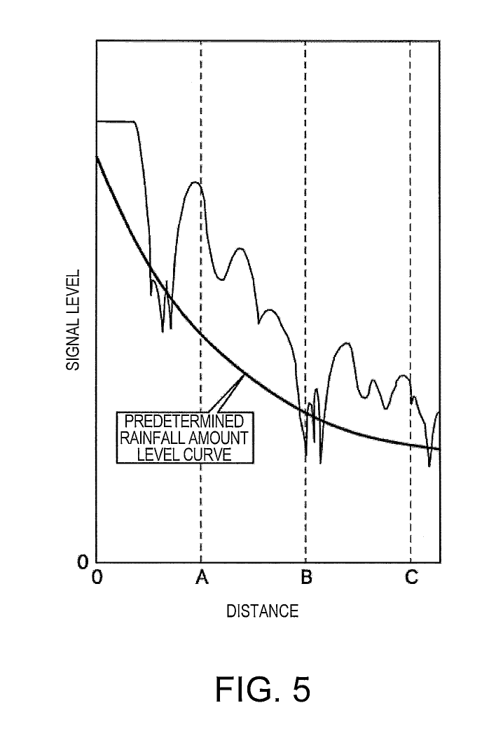

In this embodiment, Equation (10) obtained from the radar equation as described above is used as the equation of the received power of the distance R and the rainfall “r” (predetermined rainfall amount level) when transmitting a detection signal of the pulse width τ from a radar of the wavelength λ, the transmission power Pt, and the antenna gain G. As an example, FIG. 5 shows a curve of the predetermined rainfall amount level by a thick line where the received power Pr found from Equation (10) are plotted while changing the distance R.

The section determination module 11 finds the number of the received data exceeding the predetermined rainfall amount level curve among the received data of N points within the distance range currently processed (S104), and sets the number of the received data to the over_rain_num value for the distance range concerned.

Then, the section determination module 11 determines whether each distance range is the “rain-snow/noise section” or the “land/target-object section” using the three parameters described above (S105). Specifically, the section determination module 11 sets a threshold to each of the three parameters in advance, and if all of the three parameters are below the threshold, it then determines the distance range concerned to be the “rain-snow/noise section.” On the other hand, if there is at least a parameter exceeding its threshold, the section determination module 11 determines the distance range to be the “land/target-object section.”

For example, the th_width value shows a variation in the signal level of the received data within a distance range. Neither the rain-and-snow clutters nor the white noise varies in signal level over a wide range. On the other hand, the echo from the land or target object may be detected with various signal levels. Accordingly, a suitable threshold is set to the th_width value, and if the th_width value calculated for a certain distance range is above the threshold (if the signal level varies over a wide range), the section determination module 11 determines that the echoes from the land(s) or target object(s) are dominant in the received data within the distance range concerned, and then determines the distance range to be the “land/target-object section.”

The max_min_width value indicates an amplitude of the variation in the signal level. If the received data within the distance range contains only the rain-and-snow clutters and the white noises, the signal level will not vary greatly. On the other hand, if a portion containing echoes from the land(s) or target object(s) and a portion not containing the echoes from the land(s) or target object(s) are mixed in the distance range, the signal level varies greatly in the distance range. Accordingly, a suitable threshold is set to the max_min_width value, and if the max_min_width value calculated for a certain distance range is above the threshold, the section determination module 11 determines that echoes from the land(s) or target object(s) are dominant in the received data within the distance range, and then determines the distance range to be the “land/target-object section.”

Note that the signal level of the received data becomes weaker as the distance range is more distant from the antenna. Therefore, the amplitude of the signal also becomes smaller as the distance range is more distant, and a difference between the maximum value and the minimum value also becomes smaller accordingly. For this reason, in this embodiment, the threshold is set in advance so that the threshold to be compared with the max_min_width value becomes smaller as the distance range is more distant from the antenna.

The over_rain_num value indicates the number of the data more than the predetermined rainfall amount. Even if the rainfall is a lot, it is highly unlikely that that all the received data of N points within the distance range indicates the rain-and-snow clutters, for example. That is, it can be considered that more than a predetermined number of the rain-and-snow clutters which are more than the predetermined signal level are not detected in one distance range. On the other hand, because the land(s) or the target(s) object exists/exist spatially continuously, almost all the received data within a distance range may indicate the echoes from the land(s) or target object(s). Therefore, a suitable threshold is set to the over_rain_num value, and if the over_rain_num value calculated for a certain distance range is above the threshold, the section determination module 11 determines that the echoes from the land(s) or target object(s) are dominant in the received data within the distance range, and then determines the distance range to be the “land/target-object section.”

Then, if all the three parameters obtained for a certain distance range (th_width, max_min_width and over_rain_num values) are below the threshold, respectively, the section determination module 11 determines that the rain-and-snow clutters or the white noises are dominant in the distance range concerned, and thus, determines the distance range concerned to be the “rain-snow/noise section.”

Next, the threshold output module 12 is described. The threshold output module 12 includes an internal data basis threshold calculation module 14, a threshold interpolation module 15, a threshold determination module 16, and a threshold smoothing module 17.

As described above, for the distance range determined to be the “rain-snow/noise section,” the rain-and-snow clutter removing threshold can be calculated appropriately based on the received data within the distance range. When a certain distance range is determined to be the “rain-snow/noise section,” a function of the internal data basis threshold calculation module 14 is called (S106 in FIG. 2).

The internal data basis threshold calculation module 14 calculates, based on the received data within the distance range determined to be the “rain-snow/noise section,” the rain-and-snow clutter removing threshold (internal data basis threshold) for the distance range. In this embodiment, a signal level corresponding to 20% of the histogram integrated value of the received data within the distance range is set to the rain-and-snow clutter removing threshold (internal data basis threshold) for the distance range. Thereby, most of the rain-and-snow clutters and the like in the distance range can be removed.

On the other hand, for the distance range determined to be the “land/target-object section,” the rain-and-snow clutter removing threshold cannot be calculated appropriately based on the received data within the distance range. For this reason, if a certain distance range is determined to be the “land/target-object section,” a function of the threshold interpolation module 15 or the threshold determination module 16 is called (S107 in FIG. 2).

If the distance range currently processed is the “land/target-object section” and all the other distance ranges adjacent front and rear in the distance direction to the distance range are the “rain-snow/noise sections,” the threshold interpolation module 15 calculates the rain-and-snow clutter removing threshold for the distance range currently processed by interpolation. In this embodiment, the threshold interpolation module 15 calculates the rain-and-snow clutter removing threshold for the distance range currently processed by carrying out straight line interpolation of the internal data basis thresholds for the “rain-snow/noise sections” adjacent to the distance range currently processed.

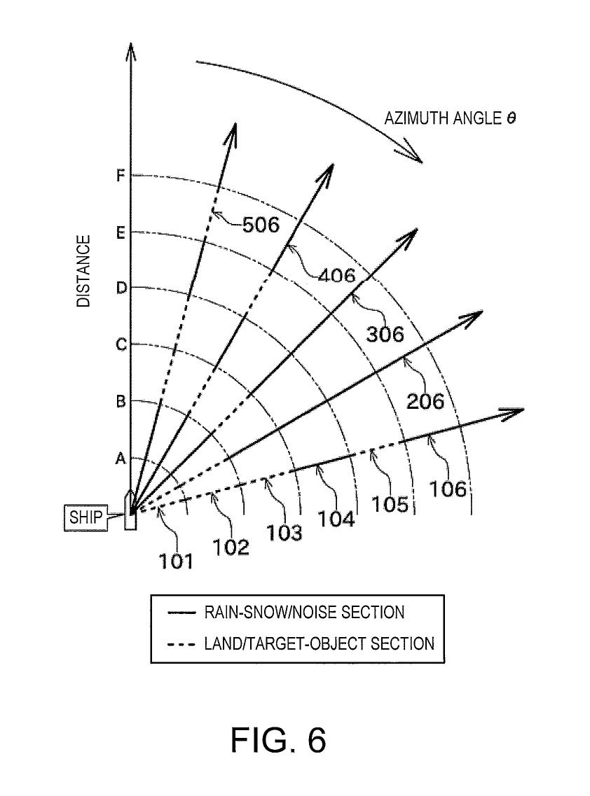

For example, in the schematic diagram of FIG. 6, distance ranges 104 and 106 determined to be the “rain-snow/noise section” are located adjacent front and rear in the distance direction to a distance range 105 determined to be the “land/target-object section.” In such a case, the threshold interpolation module 15 adopts a mean value of the internal data basis threshold for the distance range 104 and the internal data basis threshold for the distance range 106 as the rain-and-snow clutter removing threshold for the distance range 105.

On the other hand, if the distance range currently processed is the “land/target-object section,” and any one of the distance ranges adjacent front and rear in the distance direction to the distance range concerned is the “land/target-object section,” the threshold determination module 16 calculates the rain-and-snow clutter removing threshold for the distance range currently processed based on the radar equation described above.

For example, in FIG. 6, other distance ranges which are the “land/target-object sections” are located adjacent in the distance direction to the distance ranges 101, 102, 103, and the like determined to be the “land/target-object sections.” In such a case, depending on the interpolation by the threshold interpolation module 15, the rain-and-snow clutter removing threshold of the distance range concerned cannot be calculated. Therefore, in this embodiment, the rain-and-snow clutter removing threshold is hypothetically calculated based on the radar equation.

Specifically, substituting a distance of the distance range currently processed into Equation (10) of the received power, the rain-and-snow clutters level in the distance range concerned can be calculated. For example, if the distance range currently processed is within a range from the distance A to the distance B, the rainfall amount level is calculated by substituting R=(A+B)/2 (distance of the midpoint of the distance range) into Equation (10). Then, a value obtained by subtracting a predetermined offset from the predetermined rainfall amount level is adopted as the rain-and-snow clutter removing threshold for the distance range concerned. As described above, by subtracting the offset, it can leave the echoes from the land(s) or target object(s) with greater intensities.

Next, the threshold smoothing module 17 is described.

Because the rain-and-snow clutter removing threshold calculated as described above is calculated individually for each distance range, if the rain-and-snow clutter removing thresholds differ greatly between the distance ranges adjacent in the distance direction or the azimuth direction, the radar image displayed on the display 8 cannot be displayed smoothly.

For this reason, when the rain-and-snow clutter removing threshold for the distance range currently processed is found, the threshold smoothing modules 17 smoothes the rain-and-snow clutter removing thresholds in the distance direction and the azimuth direction (S108 in FIG. 2).

The smoothing of the thresholds in the azimuth direction is described. The threshold smoothing module 17 has a buffer for storing the rain-and-snow clutter removing thresholds for five sweeps, for example. The threshold smoothing module 17 performs smooth processing in the azimuth direction by taking five-point moving average of the distance range currently processed.

For example, in FIG. 6, if taking the five-point moving average of the rain-and-snow clutter removing thresholds for the distance range 106, the threshold smoothing module 17 calculates an average value of the rain-and-snow clutter removing thresholds for the distance ranges located with the same distance as the distance range 106 (specifically, the distance ranges 106, 206, 306, 406, and 506) for the five sweeps in the past including the present time. Then, the threshold smoothing module 17 sets the average value to the rain-and-snow clutter removing threshold for the distance range 106.

Next, the smoothing in the distance direction is described. The threshold smoothing module 17 smoothes the rain-and-snow clutter removing thresholds according to the number of sampling points between the adjacent distance ranges in the distance direction. In this embodiment, a rain-and-snow clutter removing threshold carried out the straight line interpolation from the rain-and-snow clutter removing thresholds for the front and rear distance ranges is calculated for the respective received data of N points.

Note that, although the rain-and-snow clutter removing threshold is set for every distance range until the smoothing of the thresholds in the azimuth direction is performed, the rain-and-snow clutter removing threshold is individually set to the respective received data of N points within the distance range in the smoothing of the thresholds in the distance direction. Therefore, because the rain-and-snow clutter removing threshold varies smoothly in the distance direction, a smooth radar image can be displayed on the display 8 without the radar image being non-smoothed at a boundary or boundaries of the distance ranges.

Then, when the rain-and-snow clutter removing threshold is set to each received data as described above, the rain-and-snow clutter removing threshold is outputted to the gain control module 13. Here, the gain control module 13 is also inputted with the received data corresponding to the rain-and-snow clutter removing threshold. Then, the gain control module 13 compares the signal level of the received data with the rain-and-snow clutter removing threshold, and only when the signal level of the received data is above the rain-and-snow clutter removing threshold, the received data is outputted to the image memory 7.

As described above, the radar device of this embodiment is provided with the section determination module 11. The section determination module 11 extracts received data within a predetermined distance range out of the series of received data for which the received signals are sampled, and determines whether the distance range is the “land/target-object section” or the “rain-snow/noise section” using the extracted received data.

Thereby, for each distance range, the removal processing of the rain-and-snow clutters can be changed according to whether the distance range is a distance range where the rain-and-snow clutters or the white noises are dominant. Therefore, because the suitable removal of the rain-and-snow clutters can be performed for every distance range, the rain-and-snow clutters can be advantageously suppressed, leaving the echoes from the land(s) or target object(s).

In addition, the radar device of this embodiment is constituted as follows. That is, the section determination module 11 calculates a cumulative frequency, where the signal level is used as a class value, for the received data within the predetermined distance range, and when a width of the class value corresponding to a predetermined range of the cumulative frequency exceeds a predetermined value, it determines that the distance range concerned is the “land/target-object section.”

That is, because the signal level of the rain-and-snow clutters has a tendency for the varying width to be small, the width of the signal level corresponding to the predetermined range of the cumulative frequency becomes narrow. On the other hand, because the echo from the land or target object can be detected in a wide range of the signal level, the width of the signal level corresponding to the predetermined range of the cumulative frequency becomes wide. Therefore, for the received data within a certain distance range, if the width of the signal level corresponding to the predetermined range of the cumulative frequency exceeds a predetermined value, it can be determined that the distance range is not a distance range where the rain-and-snow clutters or the white noises are dominant.

In addition, the radar device of this embodiment is constituted as follows. That is, the section determination module 11 calculates a maximum value and a minimum value of the signal level for the received data within each distance range, and if a difference of the maximum value and the minimum value exceeds a predetermined value, it determines that the distance range concerned is the “land/target-object section.”

That is, because the signal level of the rain-and-snow clutters has a tendency for the varying width to be small, a difference of a maximum value and a minimum value of the signal level becomes comparatively small. On the other hand, if there are a portion having echoes from the land(s) or target object(s) and a portion not having the echoes from the land(s) or target object(s) within a distance range, the difference of the maximum value and the minimum value of the signal level becomes large. For this reason, for the received data within a certain distance range, if the difference of the maximum value and the minimum value of the signal level exceeds a predetermined value, it can be determined that the distance range is not a distance range where the rain-and-snow clutters or the white noises are dominant.

In addition, the radar device of this embodiment may be constituted as follows. That is, the section determination module 11 calculates a rainfall amount level corresponding to a predetermined rainfall based on the radar equation, and for the received data within a predetermined distance range, obtains the number of the received data having a signal level exceeding the rainfall amount level, and if the number of the received data exceeding the rainfall amount level is above a predetermined value, it determines that the distance range concerned is the “land/target-object section.”

That is, it is hard to consider that more than a predetermined number of the rain-and-snow clutters having the predetermined signal level or more are detected. On the other hand, if a large land or the like exists within the distance range, the echoes more than the predetermined signal level may be detected continuously. Therefore, if the number of the received data which indicate the signal level more than the predetermined rainfall amount level exceeds a predetermined value, it can be determined that the distance range is not a distance range where the rain-and-snow clutters or the white noises are dominant.

In addition, the radar device of this embodiment may be constituted as follows. That is, the radar device suppresses the rain-and-snow clutters contained in the received data based on the rain-and-snow clutter removing threshold. The radar device is also provided with the threshold output module 12 for determining the rain-and-snow clutter removing threshold for each predetermined distance range. The threshold output module 12 also includes the internal data basis threshold calculation module 14. Based on the received data within the distance range determined to be the “rain-snow/noise section,” the internal data basis threshold calculation modules 14 calculates an internal data basis threshold as the rain-and-snow clutter removing threshold for the distance range concerned.

That is, for the distance range where the rain-and-snow clutters or the white noises are dominant, the rain-and-snow clutter removing threshold for suppressing the rain-and-snow clutters contained in the received data concerned can be calculated appropriately based on the received data within the distance range.

In addition, in the radar device of this embodiment, the threshold output module 12 includes the threshold interpolation module 15. The threshold interpolation module 15 calculates the rain-and-snow clutter removing threshold for the distance range determined to be the “land/target-object section.” The threshold interpolation module 15 determines the rain-and-snow clutter removing threshold based on the internal data basis threshold for other distance ranges adjacent to the distance range of which the rain-and-snow clutter removing threshold is to be calculated and the distance ranges determined to be the “rain-snow/noise section.”

It is difficult to calculate the threshold for suppressing the rain-and-snow clutters based on the received data within the distance range where the rain-and-snow clutters or the white noises are not dominant. For this reason, in this embodiment, the threshold for a distance range where the rain-and-snow clutters or the white noises are not dominant can be calculated based on the threshold for other adjacent distance ranges, without using the received data within the distance range concerned. Therefore, because the calculation of the threshold based on the unsuitable data can be prevented, only the rain-and-snow clutters can be advantageously suppressed in the distance range concerned, leaving the echoes from the land(s) or target object(s).

In the radar device of this embodiment, the threshold output module 12 includes a threshold determination module 16. The threshold determination modules 16 adopts a value obtained by subtracting a predetermined offset from the rainfall amount level calculated based on the radar equation for the distance range determined to be the “land/target-object section” as the rain-and-snow clutter removing threshold.

It is difficult to calculate the threshold for suppressing the rain-and-snow clutters based on the received data within the distance range where the rain-and-snow clutters or the white noises are not dominant. In this embodiment, even if the distance ranges for which the internal data basis thresholds are calculated are not located adjacent to the distance range concerned, the threshold can be determined for the distance range concerned where the rain-and-snow clutters or the white noises are not dominant. In addition, by using the value obtained by subtracting the predetermined offset from the rainfall amount level as the threshold, the echoes from the land(s) or target object(s) can be left certainly.

Although the embodiment of the present invention is described above, the configuration described above may be modified as follows.

In the above embodiment, although the rain-and-snow clutter suppression module 10 is constituted by hardware and software, it may be constituted by exclusive hardware.

In the above embodiment, although the distance range is set to a fixed width (that is, the sampling width which divides the series of received data from the sweep memory 4 is set to a constant of N points), it is not limited to this. For example, the distance range width may be varied interlocking with the pulse width or the transmitting range. However, because a sufficient sampling number of the received data is necessary to calculate the parameters within the distance range, it is preferred to define the width of the distance range taking this point of view into consideration.

In the above embodiment, the method of determining whether each distance range is the “rain-snow/noise section” or the “land/target-object section” is merely an example, and is not limited to this. For example, without obtaining all the three parameters (“th_width,” “max_min_width,” and “over_rain_num” values), each distance range may be determined whether it is the “rain-snow/noise section,” or the “land/target-object section” based on one or two parameters among these.

The smoothing of the thresholds by the threshold smoothing module 17 may be omitted.

The radar antenna receives sea surface reflections (echoes reflected on waves at a sea surface) as well as the rain-and-snow clutters. The sea surface reflection has a characteristic in which it has a powerful signal level at a position near the radar antenna, and as the distance separates from the radar antenna, the signal level falls rapidly. Therefore, what cause a problem in the radar device for ships are the powerful sea surface reflections from the position near the radar antenna.

The sea surface reflections are similar to the echoes from the land(s) or target object(s) in that the signal levels are powerful. For this reason, in the above embodiment, the distance range where the sea surface reflections are included is determined to be the “land/target-object section.” That is, the radar device of the embodiment can distinguish the rain-and-snow clutters and the white noises from the sea surface reflections.

Note that because the signal levels of the sea surface reflections is powerful as described above, it may be difficult to simply distinguish the sea surface reflections from the echoes from the land(s) or target object(s) using the intensity of the signal level. Here, as a method of detecting the sea surface reflections, there is a method of observing the received echoes within a plane-shaped area (area having a certain stretch) and determining whether the received echo within the plane-shaped area has a characteristic of the sea surface reflections. By this method, if the sea surface reflections are tried to be distinguished from the rain-and-snow clutters, an enormous amount of data is required to treat the data of the plane-shaped area. On the other hand, because the rain-and-snow clutters are uniformly distributed with a comparatively weak signal level, their characteristic can be detected only by the statistical processing of the received data in the distance direction (received data for each distance range). In this point of view, the configuration of the above embodiment can be said that it is advantageously effective in that the rain-and-snow clutters and the sea surface reflections can be distinguished with a small amount of data.

In the embodiment, if the rain-and-snow clutters and the white noise are treated as having the same characteristic, a clear difference will appear in the average signal levels of the rain-and-snow clutters and the white noises as the rainfall increases. Thus, it can be determined whether it is raining in an area of the distance range by checking the average signal level of the distance range determined to be the “rain-snow/noise section.” Here, as described above, the sea surface reflections are excluded in advance from the “rain-snow/noise section.” Therefore, only the area where rain is falling can be distinguished and detected, while various clutters and white noises are detected.

According to the above configuration, for example, only the rain-and-snow clutters can be displayed on the display 8 so as to be classified by color, or only the area where the rain-and-snow clutters are detected can be displayed on the display 8 so as to be filled by a translucent color. Thereby, an operator can recognize intuitively the area where the rain is falling.

Because the area where rain is falling can be detected as described above, it may be possible to predict a motion of rain clouds to some extent. Thereby, the operator can operate a ship or the like according to the weather condition.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

What is claimed is:

1. A radar device comprising a determination module for extracting received data within a predetermined distance range out of a series of received data for which received signals are sampled, and determining whether the distance range is a distance range where rain-and-snow clutters or white noises are dominant, using the extracted received data.

2. The radar device of claim 1, wherein the determination module calculates a cumulative frequency with a signal level being a class value, for the extracted received data within the predetermined distance range, and determines whether the distance range is a distance range where the rain-and-snow clutters or the white noises are dominant based on whether a width of the class value corresponding to the predetermined range of the cumulative frequency is above a predetermined value.

3. The radar device of claim 1, wherein the determination module calculates a maximum value and a minimum value of the signal level for the extracted received data within the predetermined distance range, and determines whether the distance range is a distance range where the rain-and-snow clutters or the white noises are dominant based on whether a difference of the maximum value and the minimum value is above a predetermined value.

4. The radar device of claim 1, wherein the determination module calculates a rainfall amount level corresponding to a predetermined rainfall based on a radar equation, obtains the number of the received data having a signal level exceeding the rainfall amount level for the extracted received data within the predetermined distance range, and determines whether the distance range is a distance range where the rain-and-snow clutters or the white noises are dominant based on whether the number of the received data exceeding the rainfall amount level is above a predetermined value.

5. The radar device of claim 1, wherein the radar device suppresses the rain-and-snow clutters contained in the received data based on a threshold, and further comprises a threshold output module for determining the threshold for each predetermined distance range, the threshold output module including an internal data basis threshold calculation module for calculating an internal data basis threshold as the threshold for the distance range based on the received data within the distance range determined to be the distance range where the rain-and-snow clutters or the white noises are dominant.

6. The radar device of claim 5, where the threshold output module includes a threshold interpolation module for calculating the threshold for the distance range determined to be the distance range where the rain-and-snow clutters or the white noises are not dominant, the threshold interpolation module determining the threshold based on the internal data basis threshold for the distance range determined to be the distance range where the rain-and-snow clutters or the white noises are dominant, the distance range being other distance ranges adjacent to the distance range concerned for which the threshold is to be calculated.

7. The radar device of claim 5, wherein the threshold output module includes a threshold determination module for adopting as the threshold a value obtained by subtracting a predetermined offset from the rainfall amount level calculated based on the radar equation for the distance range determined to be the distance range where the rain-and-snow clutters or the white noises are not dominant.
